(19) United States
(12) Patent Application Publication
(10) Pub. No.: US 2005/0077783 A1
(43) Pub. Date: Apr. 14, 2005

(54) Electric parking brake system and control method for the electric parking brake

(76) Inventors: Hidetoshi Suzuki, Hamamatsu-shi (JP); Eiji Ina, Toyohashi-shi (JP)

Correspondence Address: Marsh Fischmann & Breyfogle LLP;Suite 411, 3151 South Vaughn Way, Aurora, CO, 80014, US

(21) Appl. No.: 10/963,695

(22) Filed: Oct. 13, 2004

(30) Foreign Application Priority Data
Oct. 14, 2003 (JP) 2003-353554

(51) Int. Cl. F16D 55/26

(52) U.S. Cl. 303/89

(57) ABSTRACT

A friction member driven by a motor is pressed against a rotating element that rotates integrally with a wheel to give a pressing force to the rotating element, thereby applying braking force to the wheel. Control means controls the control circuit that controls the motor. In order to apply braking force to the wheel, the control means commands the control circuit to drive the motor once or a plurality of times at a predetermined time interval. Determining means determines a temperature of the friction member at the time when the parking brake starts braking the wheel. Setting means sets at least one of the number of driving of the motor, the time interval, and the target value of the pressing force. Therefore, a steady braking force with high efficiency is generated.

### BACKGROUND OF THE INVENTION

The present invention relates to an electric parking brake system and a control method for the electric parking brake.

A vehicular parking brake system including an electric parking brake using a motor as a driving source gives a braking force to a wheel by pressing a friction member (pad or shoe) on a rotating element (rotor or drum) rotating integrally with the wheel.

In this parking brake system, since the friction member and its support member (caliper or drum) have much different thermal expansion coefficients, when parking braking is performed in a state in which the friction member is hot due to heat generation caused by the braking operation during the running of a vehicle, the braking force decreases with time. When the friction member is always pressed on the rotating element with a strong pressing force considering such a decrease in braking force with time, the system becomes large in size to ensure rigidity capable of withstanding the pressing force.

Conventionally, in order to prevent the decrease in braking force with time due to the difference in thermal expansion coefficient between the friction member and the support member, a control method for an electric parking brake has been used in which at the time of parking braking, after predetermined time has elapsed after the friction member has been pressed on the rotating element, a brake is operated again to apply braking force to wheels. The use of such a control method gives a steady braking force to the wheel without increasing the system size (refer to Japanese Laid-Open Patent No. 2002-225701).

However, the above-described conventional control method has a problem in that even when the temperature of the friction member is not in the temperature range in which the braking force decreases with time due to the difference in thermal expansion coefficient, wasteful energization occurs because the brake is operated again, which results in a low efficiency in terms of power consumption.

### SUMMARY OF THE INVENTION

An object of the present invention is to provide an electric parking brake system capable of generating a steady braking force with high efficiency and a control method for the electric parking brake.

To achieve the above-mentioned objective, the present invention provides an electric parking brake system for applying braking force to a wheel of a vehicle. The system includes an electric parking brake having a rotating element that rotates integrally with the wheel, a friction member that can be pressed against the rotating element, and a motor. The friction member driven by the motor is pressed against the rotating element to give a pressing force to the rotating element, thereby applying braking force to the wheel. A control circuit controls the motor. Control means controls the control circuit. In order to apply braking force to the wheel, the control means commands the control circuit to drive the motor once or a plurality of times at a predetermined time interval. Determining means determines a temperature of the friction member at the time when the parking brake starts braking the wheel. Setting means sets at least one of the number of driving of the motor, the time interval, and the target value of the pressing force. The control means controls the control circuit according to the setting result by the setting means.

Another aspect of the present invention provides a method for controlling an electric parking brake that applies braking force to a wheel of a vehicle. The brake has a rotating element that rotates integrally with the wheel, a friction member that can be pressed against the rotating element, and a motor. The method includes controlling the motor to press the friction member against the rotating element to give a pressing force to the rotating element, thereby applying braking force to the wheel. The motor is driven once or a plurality of times at a predetermined time interval in order to apply braking force to the wheel. A temperature of the friction member at the time when the parking brake starts braking the wheel is determined. At least one of the number of driving of the motor, the time interval, and the target value of the pressing force are set. The motor is controlled according to the setting result.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic view of an electric parking brake system in accordance with one embodiment embodying the present invention;

FIG. 2 is a time chart showing the relationship between the control mode of the system shown in FIG. 1 and a braking force generated by the electric parking brake;

FIG. 3 is an explanatory view of a decision table used in the system shown in FIG. 1;

FIGS. 4 to 6 are time charts showing the relationship between the control mode of the system shown in FIG. 1 and a braking force generated by the electric parking brake; and

FIG. 7 is a flowchart showing a control mode at the time of parking braking operation of the system shown in FIG. 1.

### DETAILED DESCRIPTION OF THE PREFERRED EMBODIMENTS

One embodiment embodying the present invention will now be described with reference to the accompanying drawings.

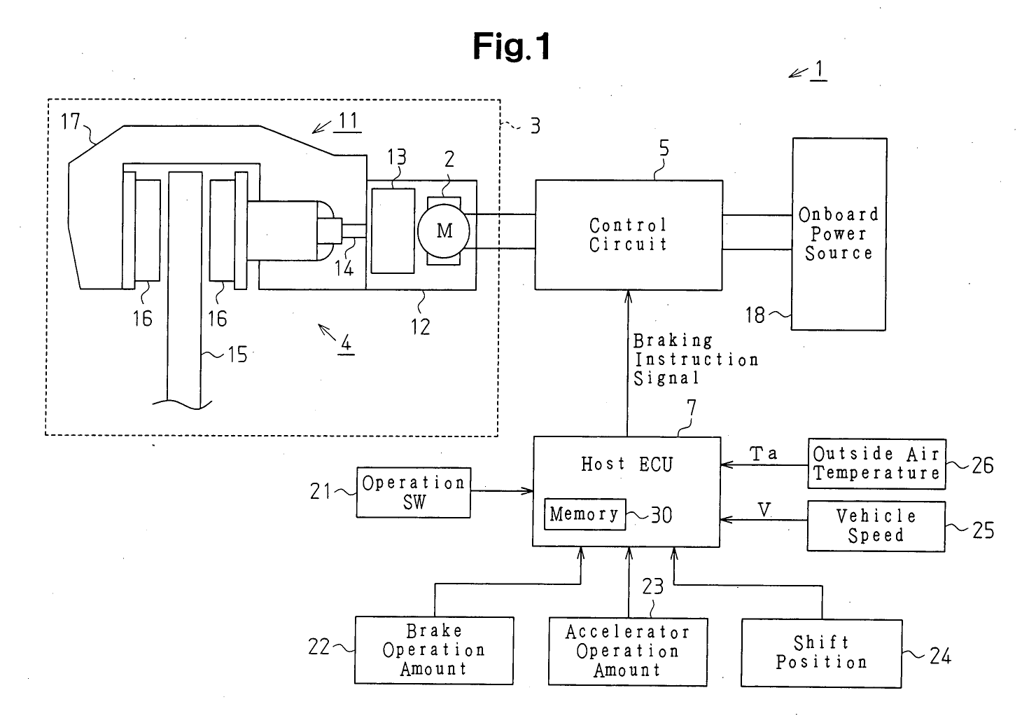

As shown in FIG. 1, an electric parking brake system 1 in accordance with this embodiment includes an electric parking brake 4 for giving a braking force to a wheel 3 with a motor 2 being used as a power source, a control circuit 5 for controlling the operation of the motor 2, that is, the operation of the electric parking brake 4, and a host ECU 7 serving as a control means for instructing the control circuit 5 to generate the braking force by using the electric parking brake 4. The host ECU 7 and the control circuit 5 serve as a control section for controlling the motor 2.

The electric parking brake 4 has a braking section 11 provided on the wheel 3 to give a braking force to the wheel 3, and an actuator 12 for driving the braking section 11. The actuator 12 drives the braking section 11 by converting the normal/reverse rotation of the motor 2 into reciprocating motion in the axial direction of an output shaft 14 with a speed reducing mechanism 13. The braking section 11 includes a rotating element 15 rotating integrally with the wheel 3, a friction member 16 pressed on the rotating element 15, and a support member 17 for supporting the friction member 16 so that the friction member 16 can move in the direction of coming close to or going away from the rotating element 15. The friction member 16 moves in the direction of coming close to or going away from the rotating element 15 by being driven by the actuator 12. The actuator 12 drives the braking section 11 by means of the rotation of the motor 2, and thus the friction member 16 presses on the rotating element 15 to give a pressing force to the rotating element 15, by which the electric parking brake 4 gives a braking force to the wheel 3.

In this embodiment, the braking section 11 of the electric parking brake 4 is a section common to the ordinary vehicle braking system (not shown) serving as a running brake other than the parking braking. Therefore, during the vehicle running, the friction member 16 is pressed on the rotating element 15 by the foot brake operation of the driver, by which a braking force is given to the wheel 3.

The motor 2 of the electric parking brake 4 (actuator 12) is connected via the control circuit 5 to an onboard power source 18, so that the motor 2 is rotated by the supply of driving power from the control circuit 5. The control circuit 5 controls the power supply to the motor 2 to control the operation of the electric parking brake 4.

The control circuit 5 is connected to the host ECU 7, and the host ECU 7 instructs the control circuit 5 to generate a braking force using the electric parking brake 4 by sending a braking instruction signal to the control circuit 5. The host ECU 7 is connected with a plurality of sensors for sensing the vehicle state, and the host ECU 7 sends the braking instruction signal to the control circuit 5 based on the inputs from these sensors. In this embodiment, the host ECU 7 is connected with an operation switch (parking brake switch) 21, a brake operation amount sensor 22, an accelerator operation amount sensor 23, a shift position sensor 24, a vehicle speedometer 25, and an outside air temperature sensor (thermometer) 26.

The host ECU 7 sets the braking instruction signal sent to the control circuit 5 based on the vehicle state sensed by the aforementioned sensors, i.e., any one of the on/off of the operation switch 21, the operation amount of brake pedal, the operation amount of accelerator pedal, the shift position, the speed of vehicle, and the outside air temperature or a predetermined combination of these.

For example, when the operation switch is on and the accelerator pedal is off, the host ECU 7 instructs the control circuit 5 to generate a braking force using the electric parking brake 4, and when the operation switch 21 is off and the brake pedal operation amount is enough to give a sufficient braking force to the vehicle, the host ECU 7 instructs the control circuit 5 to release the brake. The control circuit 5 controls the operation of the electric parking brake 4 based on the braking instruction signal sent from the host ECU 7.

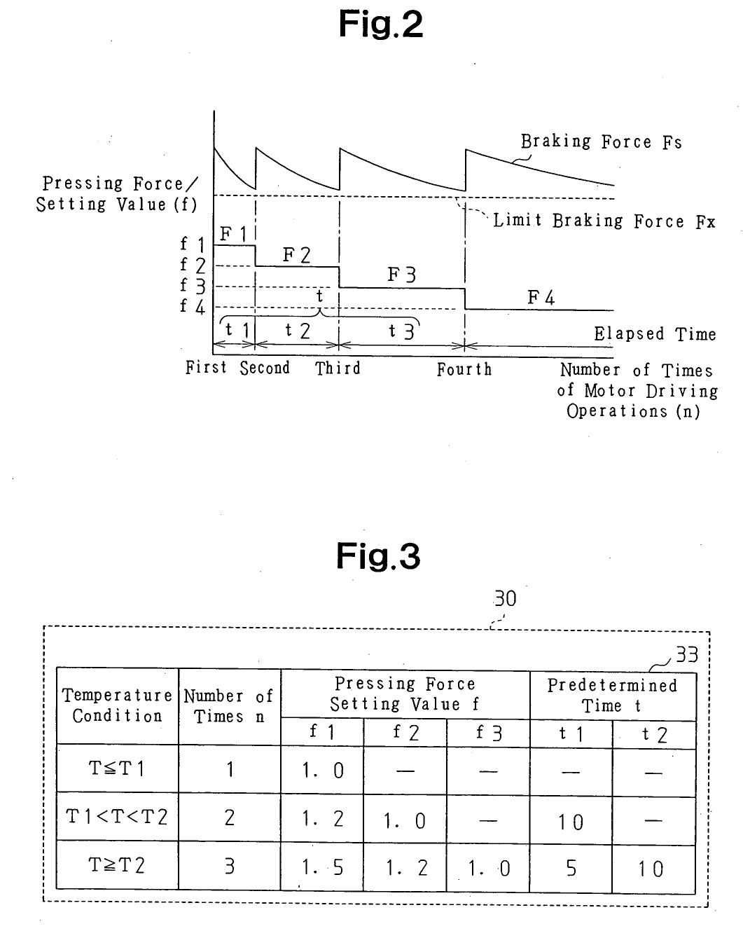

As shown in FIG. 2, in this embodiment, at the time of parking braking, the host ECU 7 commands the control circuit 5 to drive the motor 2 once or several times at a predetermined time interval t (t1 to t3), thereby applying braking force to the wheel 3. The control circuit 5 controls the brake 4 based on the braking instruction signal sent from the host ECU 7 so that the friction member 16 is pressed on the rotating element 15. When the braking instruction signal instructs the control circuit 5 to drive the motor 2 several times, the control circuit 5 drives the electric parking brake 4 again after a predetermined time interval t (t1 to t3) has elapsed, thereby applying braking force to the wheel 3 through the friction member 16. By repeating the above-described repetitive driving of the motor 2, a braking force (braking torque) Fs generated by the electric parking brake 4 is held at a limit braking force Fx or higher even when the friction member 16 is in a high temperature state due to heat generation caused by braking during vehicle running, that is, even in parking braking in a situation in which a decrease in braking force with time is liable to occur due to a difference in thermal expansion coefficient between the friction member 16 and the support member 17.

Specifically, the host ECU 7 functions as determining means that determines the temperature of the friction member 16 based on the sensed-vehicle state. The host ECU 7 further functions as setting means that, based on the determined temperature, sets the number of times n of driving the motor 2 for applying braking force to the wheel 3, the predetermined time intervals t (t1 to t3) from driving of the motor 2 to the next driving of the motor 2, and pressing force target values f (f1 to f4) for pressing the friction member 16 against the rotating element 15 when the motor 2 is driven. Driving the motor 2 for applying braking force to the wheel 3 corresponds to the pressing operation of the friction member 16 against to the rotating element. That is, the number of times n of driving the motor 2 for applying braking force to the wheel 3 corresponds to the number of pressing operation of the friction member 16 against to the rotating element 15. The predetermined time intervals t (t1 to t3) from driving of the motor 2 to the next driving of the motor 2 corresponds to the intervals from pressing operation of the friction member 16 to the next pressing operation.

In this embodiment, the host ECU 7 changes the predetermined time intervals t1 to t3 between the driving operations of the motor 2 and the pressing force target values f1 to f4 in each driving operation every time the motor 2 is driven. The host ECU 7 sends the number of times n of driving operations of the motor 2, the predetermined time intervals t1 to t3, and the pressing force target values f1 to f4 to the control circuit 5 as the braking instruction signal.

Based on the inputted braking instruction signal, the control circuit 5 changes the predetermined time intervals t1 to t3 and pressing forces F1 to F4 (corresponding to the pressing force target values f1 to f4) every time the motor 2 is driven, thereby the motor 2 is driven n times to apply pressing forces F1 to F4 to the rotating element 15 to apply the braking force to the wheel 3.

The pressing force target value f is expressed by the power supply condition to the motor 2 under which the control circuit 5 controls the electric parking brake 4, that is, at least one of the applied voltage to the motor 2, the current amount, the energizing time, and the position of the friction member 16. Hereunder, for convenience of explanation, the value f is expressed by a coefficient determined with the pressing force of the friction member 16 at ordinary temperature being one.

Further specifically, in this embodiment, the host ECU 7 estimates the temperature of the friction member 16 based on a change in the vehicle speed when the vehicle is running and the outside air temperature. Specifically, the host ECU 7 successively calculates deceleration energy W (kinetic energy decreased by deceleration) at the time of vehicle braking from an equation of W=m×(V1²−V2²)/2 based on the vehicle speed change (vehicle speed V1 before deceleration, vehicle speed V2 after deceleration) during running, which is detected by the vehicle speedometer 25, and the mass m of vehicle.

The host ECU 7 calculates a temperature increase ΔTb of the friction member 16 from an equation of ΔTb=k×C×W based on a conversion coefficient k and the heat capacity C of the friction member 16, and further successively calculates a temperature decrease ΔTr of the friction member 16 from an equation of ΔTr=S×h based on a heat radiation coefficient h depending on both an outside air temperature Ta sensed by the outside air temperature sensor 26 and a vehicle speed V and the heat dissipation area S of the friction member 16.

The heat radiation coefficient h increases with an increase in vehicle speed V or with a decrease in the outside air temperature Ta. In this embodiment, the host ECU 7 does not calculate, based on the information sent from the sensors of the brake operation amount sensor 22, the accelerator operation amount sensor 23, and the shift position sensor 24, the temperature increase ΔTb of the friction member 16 at the time of deceleration other than the case where the foot brake is operated, that is, at the time of deceleration by engine brake or at the time of natural deceleration.

The host ECU 7 estimates the temperature T of the friction member 16 at the time of parking braking start by time integration, that is, summation of a temperature change AT expressed by the temperature increase ΔTb and the temperature decrease ΔTr of the friction member 16 calculated as described above.

As shown in FIG. 1, the host ECU 7 includes a memory 30. The memory 30 stores a decision table 33 in which the number of times n of driving operations of the motor 2, the predetermined time intervals t, and the pressing force target values f in each driving operation every time the motor 2 is driven corresponding to the temperature T of the friction member 16 are recorded (refer to FIG. 3). In this embodiment, for the number of times n of driving operations of the motor 2, the predetermined time intervals t, and the pressing force target values f, which correspond to the temperature T of the friction member 16, an optimum pattern is set in advance by an experiment (including calculation and simulation) etc., and recorded in the decision table 33.

The host ECU 7 sets, based on the decision table 33, the number of times n of driving operations of the motor 2, the predetermined time interval t, and the pressing force target value f in each driving operation every time the motor 2 is driven corresponding to the estimated temperature T of the friction member 16. The host ECU 7 sends the setting results to the control circuit 5 as a braking instruction signal. Based on the braking instruction signal, the control circuit 5 drives the motor 2 to press the friction member 16 against the rotating element 15. Thereafter, when a predetermined time interval t has elapsed, control circuit 5 controls the electric parking brake 4 to drive the motor 2 again.

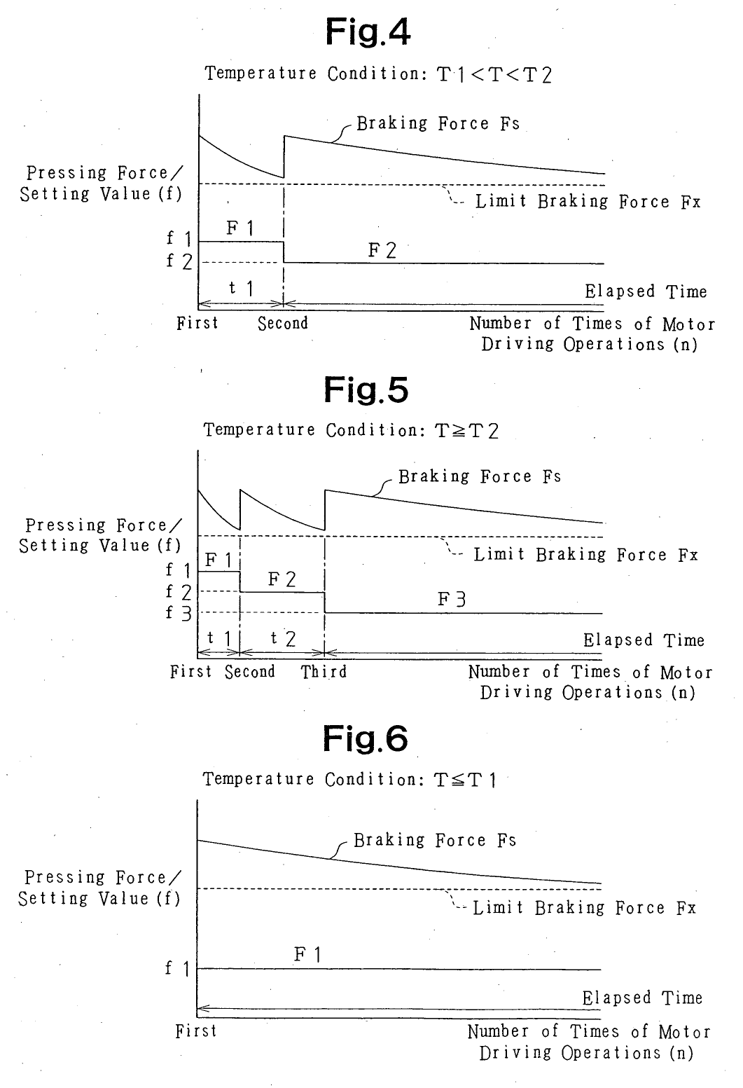

For example, as shown in FIG. 4, in the case where the estimated temperature T (the estimated temperature) of the friction member 16 is higher than a predetermined temperature T1 (150° C., for example) and lower than a predetermined temperature T2 (300° C., for example), the host ECU 7 sets that the number of times of driving operations of the motor 2 is two (n=2), that the predetermined time interval t1 (10 minutes, for example), and that the pressing force target values f1 and f2 are, for example, 1.2 and 1.0 based on the decision table 33. The host ECU 7 sends these results to the control circuit 5 as a braking instruction signal. The control circuit 5 first drives the motor 2 such that the friction member 16 is pressed on the rotating element 15 with a pressing force F1 (1.2) corresponding to the pressing force target value f1. Then, after the predetermined time interval t1 (10 minutes) has elapsed, the control circuit 5 controls the motor 2 to perform a second driving operation of the motor 2 with a pressing force F2 (1.0) corresponding to the pressing force target value f2. Thereby, the braking force Fs generated by the electric parking brake 4 is held at the limit braking force Fx or higher.

As shown in FIG. 5, in the case where the estimated temperature T is equal to or higher than the predetermined temperature T2, the host ECU 7 sets that the number of times of driving operations of the motor 2 is three (n=3), that the predetermined time intervals t1 and t2 are, for example, 5 minutes and 10 minutes, and that the pressing force target values f1, f2 and f3 are, for example, 1.5, 1.2 and 1.0. The host ECU 7 sends these values to the control circuit 5 as a braking instruction signal. The control circuit 5 first drives the motor 2 such that the friction member 16 is pressed on the rotating element 15 with a pressing force F1 (1.5) corresponding to the pressing force target value f1. After the predetermined time interval t1 (5 minutes) has elapsed, the control circuit controls the motor 2 to perform a second driving operation of the motor 2 with a pressing force F2 (1.2) corresponding to the pressing force target value f2. Subsequently, after the predetermined time interval t2 (10 minutes) has further elapsed, the control circuit 5 controls the motor 2 such that a third driving operation of the motor 2 is performed with a pressing force F3 (1.0) corresponding to the pressing force target value f3. Thereby, the braking force Fs generated by the electric parking brake 4 is held at the limit braking force Fx or higher.

As shown in FIG. 6, in the case where the estimated temperature T is equal to or lower than the predetermined temperature T1, the host ECU 7 sets that the number of times of driving operations of the motor 2 is one (n=1), that the predetermined time interval t1 has no value (no setting), and that the pressing force target values f1 is 1.0, and sends these values to the control circuit 5 as a braking instruction signal. The control circuit 5 controls the motor 2 such that the motor 2 is driven to press the friction member 16 on the rotating element 15 with a pressing force F1 (1.0) corresponding to the pressing force target value f1 based on this braking instruction signal.

That is, in this embodiment, when the number of times of driving operations of the motor 2 specified in the braking instruction signal is one (n=1), i.e., the estimated temperature T of the friction member 16 is in the temperature range in which the braking force hardly decreases with time due to the difference in thermal expansion coefficient between the friction member 16 and the support member 17, and the braking force Fs generated by the electric parking brake 4 is higher than the limit braking force Fx, the control circuit 5 does not perform the driving operation of the motor 2 again.

Next, the control mode of the electric parking brake system in accordance with this embodiment, which is configured as described above, will be explained.

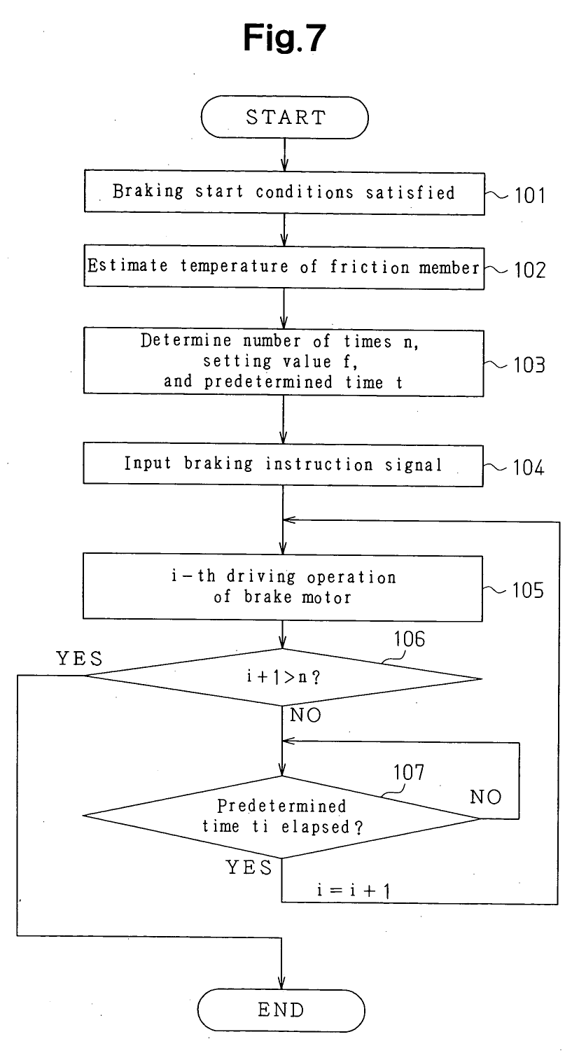

As shown in FIG. 7, if the parking braking start conditions are met (Step 101), the ECU 7 first estimates the temperature T of the friction member 16 based on the vehicle speed change and the outside air temperature (Step 102). The ECU 7 sets, based on the decision table 33, the number of times n of driving operations of the motor 2, the predetermined time intervals t, and the pressing force target values f corresponding to the estimated temperature T of the friction member 16 (Step 103), and sends the setting results in Step 103 to the control circuit 5 as a braking instruction signal (Step 104).

The control circuit 5 controls the electric parking brake 4 so that the i-th driving operation of the motor 2 is performed with a pressing force Fi corresponding to a pressing force target value fi based on the input braking instruction signal (Step 105).

Next, the control circuit 5 judges whether or not the n-th driving operation of the motor 2 specified in the input braking instruction signal has been implemented (i+1>n) (Step 106). If the control circuit 5 judges that the n-th driving operation of the motor 2 specified in the input braking instruction signal has not been implemented in Step 106, the control circuit 5 waits until predetermined time interval ti has elapsed (Step 107), and subsequently the control circuit 5 repeats the processing in Steps 105 through 107 until the specified n-th driving operation of the motor 2 is implemented (i=i+1). If it is judged in Step 106 that the specified n-th driving operation of the motor 2 has been implemented, the above series of parking braking operation is finished.

As explained above, this embodiment has the following advantages:

(1) The host ECU 7 estimates the temperature of the friction member 16 based on the vehicle state, and sets, based on the estimated temperature, the number of times n of driving operations of the motor 2 to apply braking force to the wheel 3, the predetermined time intervals t from a driving operation to the next driving operation of the motor 2, and the pressing force target values f for pressing the friction member 16 on the rotating element 15 in each driving operation. The host ECU 7 sends these results to the control circuit 5 as a braking instruction signal. The control circuit 5 drives the motor 2 once or several times based on the braking instruction signal.

By this configuration, parking brake control is carried out based on the number of times n of driving operations of the motor 2, the predetermined time intervals t, and the pressing force target values f corresponding to the estimated temperature T of the friction member 16, so that the decrease in braking force with time due to the difference in thermal expansion coefficient between the friction member 16 and the support member 17 is prevented more effectively, and also wasteful repeated driving operation of the motor 2 is not performed. That is to say, power consumption caused by the driving operation of the motor 2 is restrained, and consequently a steady braking force is given with high efficiency.

(2) The host ECU 7 estimates the temperature T of the friction member 16 based on a change in the vehicle speed when the vehicle is running and the outside air temperature. Therefore, there is no need for newly providing a sensor for directly sensing the temperature of the friction member 16. Since the temperature T of the friction member 16 can be estimated by using the speedometer 25 and the outside air temperature sensor (thermometer) 26, which are usually provided on the vehicle, a steady braking force can be given with high efficiency by a simple configuration.

(3) The host ECU 7 changes the predetermined time intervals t1 to t3 between the driving operations of the motor 2 and the pressing force target values f1 to f4 in each driving operation every time the motor 2 is driven based on the estimated temperature of the friction member 16. Therefore, a braking force can be given more effectively and efficiently.

(4). When the number of times n of driving operations of the motor 2 specified in the braking instruction signal is one, the control circuit 5 does not perform the driving operation of the motor 2 again. That is, when the estimated temperature T of the friction member 16 is in the temperature range in which the braking force hardly decreases with time due to the difference in thermal expansion coefficient between the friction member 16 and the support member 17, the control circuit 5 does not perform the driving operation of the motor 2 again. Therefore, wasteful power consumption can be restrained, and consequently a steady braking force can be given still more efficiently.

The invention may be embodied in the following forms.

In the above-described embodiment, the host ECU 7 changes the predetermined time intervals t1 to t3 and the pressing force target values f1 to f4 every time the motor 2 is driven based on the estimated temperature of the friction member 16. However, the present invention is not limited to this configuration. The configuration may be such that either of the predetermined time intervals t or the pressing force target values f is changed for each driving operation. Alternatively, the predetermined time intervals t and the pressing force target values f in each driving operation may be set at predetermined values, and only the number of times n of driving operations of the motor 2 may be changed.

In the above-described embodiment, the host ECU 7 sets, based on the temperature T of the friction member 16 estimated at the time of parking braking start, the number of times n of driving operations of the motor 2, the predetermined time intervals t (t1 to t3), and the pressing force target values f (f1 to f4). However, the present invention is not limited to this configuration. The configuration may be such that the host ECU 7 successively estimates the temperature T of the friction member 16 after the parking braking start, and performs driving operation of the motor 2 again based on the temperature T of the friction member 16 after the parking braking start.

In the above-described embodiment, the host ECU 7 sets the number of times n of driving operations of the motor 2, the predetermined time intervals t, and the pressing force target values f corresponding to the estimated temperature T of the friction member 16 based on the decision table 33 in which the number of times n of driving operations, the predetermined time intervals t, and the pressing force target values f corresponding to the temperature T of the friction member 16 are recorded. However, the present invention is not limited to this configuration. The number of times n of driving operations of the motor 2, the predetermined time intervals t, and the pressing force target values f may be setted by calculation or other methods.

The electric parking brake 4 may be of a disc brake system having a brake disc and a brake pad as the rotating element 15 and the friction member 16, or may be of a drum brake system having a brake drum and a brake shoe.

The electric parking brake 4 may be one in which the braking section and the actuator are configured integrally, or may be one in which the braking section and the actuator are arranged at separate positions.

1. An electric parking brake system for applying braking force to a wheel of a vehicle, comprising:
an electric parking brake having a rotating element that rotates integrally with the wheel, a friction member that can be pressed against the rotating element, and a motor, wherein the friction member driven by the motor is pressed against the rotating element to give a pressing force to the rotating element, thereby applying braking force to the wheel;
a control circuit for controlling the motor;
control means for controlling the control circuit, wherein, in order to apply braking force to the wheel, the control means commands the control circuit to drive the motor once or a plurality of times at a predetermined time interval;
determining means that determines a temperature of the friction member at the time when the parking brake starts braking the wheel; and
setting means that sets at least one of the number of driving of the motor, the time interval, and the target value of the pressing force, wherein the control means controls the control circuit according to the setting result set by the setting means.

2. The system according to claim 1, wherein the determining means estimates the temperature of the friction member based on the state of the vehicle.

3. The system according to claim 1, wherein the friction member functions as a running brake when the vehicle is running, and wherein the determining means estimates the temperature of the friction member based on a change in the vehicle speed when the vehicle is running and an outside air temperature.

4. The system according to claim 1, wherein the higher the determined temperature, the greater the number of driving of the motor the setting means sets.

5. The system according to claim 1, wherein the higher the determined temperature, the shorter the interval between the first driving of the motor and the second driving of the motor the setting means sets.

6. The system according to claim 1, wherein the higher the determined temperature, the greater the target value at the time when the motor is first driven the setting means sets.

7. The system according to claim 1, wherein, based on the determined temperature, the setting means changes at least one of the predetermined time interval and the target value every time the motor is driven.

8. The system according to claim 1, wherein, when the number of driving of the motor set by the setting means is one, the control circuit drives the motor only once.

9. An electric parking brake system for applying braking force to a wheel of a vehicle, comprising:
an electric parking brake having a rotating element that rotates integrally with the wheel, a friction member that can be pressed against the rotating element, and a motor, wherein the friction member driven by the motor is pressed against the rotating element to give a pressing force to the rotating element, thereby applying braking force to the wheel;
a control circuit for controlling the motor;
control means for controlling the control circuit, wherein, in order to apply braking force to the wheel, the control means commands the control circuit to drive the motor once or a plurality of times at a predetermined time interval;
estimating means for estimating the temperature of the friction member based on the state of the vehicle; and
setting means that sets the number of driving of the motor, the time interval, and the target value of the pressing force, wherein the control means controls the control circuit according to the setting result set by the setting means.

10. An electric parking brake system for applying braking force to a wheel of a vehicle, comprising:
an electric parking brake having a rotating element that rotates integrally with the wheel, a friction member that can be pressed against the rotating element, and a motor, wherein the friction member driven by the motor is pressed against the rotating element to give a pressing force to the rotating element, thereby applying braking force to the wheel;
control section for controlling the motor, wherein, in order to apply braking force to the wheel, the control section drives the motor once or a plurality of times at a predetermined time interval, determines a temperature of the friction member at the time when the parking brake starts braking the wheel, and sets at least one of the number of driving of the motor, the time interval, and the target value of the pressing force, and wherein the control section controls the motor according to the setting result.

11. A method for controlling an electric parking brake that applies braking force to a wheel of a vehicle, the brake having a rotating element that rotates integrally with the wheel, a friction member that can be pressed against the rotating element, and a motor, the method comprising:
controlling the motor to press the friction member against the rotating element to give a pressing force to the rotating element, thereby applying braking force to the wheel;
driving the motor once or a plurality of times at a predetermined time interval in order to apply braking force to the wheel;
determining a temperature of the friction member at the time when the parking brake starts braking the wheel; and
setting at least one of the number of driving of the motor, the time interval, and the target value of the pressing force, and controlling the motor according to the setting result.

12. The method according to claim 11, wherein the temperature of the friction member is estimated based on the state of the vehicle.

13. The method according to claim 11, wherein the friction member functions as a running brake when the vehicle is running, and wherein the temperature of the friction member is estimated based on a change in the vehicle speed when the vehicle is running and an outside air temperature.

14. The method according to claim 11, wherein the higher the determined temperature, the greater the number of driving of the motor is set.

15. The method according to claim 11, wherein the higher the determined temperature, the shorter the interval between the first driving of the motor and the second driving of the motor is set.

16. The method according to claim 11, wherein the higher the determined temperature, the greater the target value at the time when the motor is first driven is set.

17. The method according to claim 11, wherein, based on the determined temperature, at least one of the predetermined time interval and the target value is changed every time the motor is driven.
